(19) United States
(12) Patent Application Publication
(10) Pub. No.: US 2024/0397478 A1
(43) Pub. Date: Nov. 28, 2024

(54) MONITORING AND COMMUNICATION PLATFORM

(71) Applicant: CAREMINDR Corporation, Los Gatos, CA (US)

(72) Inventors: Harry Raymond Soza, San Jose, CA (US); Irina Yermilov, Los Angeles, CA (US); Randall Edwin Coatney, Lafayette, CO (US); Nicholas James Murphy, III, Arroyo Grande, CA (US); Cherie Lisa Deeds, Calabasas, CA (US); Jennifer Lynn Viola, Stockton, NJ (US)

(73) Assignee: CAREMINDR Corporation, Los Gatos, CA (US)

(21) Appl. No.: 18/202,169

(22) Filed: May 25, 2023

(51) Int. Cl. H04W 68/00

(52) U.S. Cl. CPC H04W 68/005

(57) ABSTRACT

An example operation may include one or more of storing a plurality of message templates corresponding to a plurality of tags, receiving, from a user device, a message with status information about a user of the user device, determining that the message comprises a type of alert from among a plurality of types of alerts, tagging the message with the type of alert, and storing the tagged message within a queue.

### TECHNICAL FIELD OF THE APPLICATION

This application relates to a communication platform and more particularly to a communication platform that enables a small team to efficiently manage a large network of patients being remotely monitored in an efficient manner.

### BACKGROUND OF THE APPLICATION

Conventionally, the approach to providing users with ongoing communications regarding a multi-step healthcare plan or other repetitive course of action may leave the majority of the work to the user. In this case, smartphones and other personal computing devices may not be properly utilized by a professional service provider when offering users options for maintaining a course of treatment or a set of goals. As a result, the professional service provider may not effectively communicate with the user and the user may not adequately understand the next steps. This can lead to personal health problems for the user and lost work and revenue for providers, insurers, etc., as well as the users.

### BRIEF DESCRIPTION OF THE DRAWINGS

FIG. 1A illustrates an example of the integrated application platform according to example embodiments.

FIG. 1B illustrates an example of communication between a software stack of a front-end and a back-end of the software application according to example embodiments.

FIG. 1C illustrates an example of an HTTP request message that may be transmitted between the front-end and back-end of the software application according to example embodiments.

FIG. 1D illustrates an example of a process of tagging patient status bubbles with visual alerts according to example embodiments.

FIG. 1E illustrates an example of a tag-to-alert mapping table according to example embodiments.

FIG. 2 illustrates a network configuration of the third-party participants of the integrated application according to example embodiments.

FIG. 3 illustrates a user smartphone interface of an example treatment plan according to example embodiments.

FIG. 4A illustrates an example setup configuration for a new course of treatment according to example embodiments.

FIG. 4B illustrates an example database entry for the new course of treatment according to example embodiments.

FIG. 4C illustrates a flow diagram configuration for the new course of treatment according to example embodiments.

FIG. 4D illustrates an example list of messages for the ongoing course of treatment according to example embodiments.

FIG. 4E illustrates an example setup configuration for various courses of treatment according to example embodiments.

FIG. 4F illustrates an example set of details of an ongoing course of treatment according to example embodiments.

FIG. 4G illustrates an example network configuration of the various third parties involved in the application operation and compliance according to example embodiments.

FIG. 5 illustrates a logic module configured to process the input and output parameters of the application according to example embodiments.

FIG. 6 illustrates an example network entity device configured to store instructions, software, and corresponding hardware for executing the same, according to example embodiments of the present application.

FIGS. 7A-7C are diagrams illustrating a process of a watchtower monitoring and communication platform according to example embodiments.

FIG. 8 illustrates a method of tagging and routing messages through a watchtower platform according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

The example embodiments are directed to a communication platform referred to herein as a “watchtower”. The platform takes certain functions (e.g., alert warnings about a patient's health status) that have been implemented in other settings (e.g., hospital monitoring equipment) and delivers them in a continuous format where the needs of each single patient is automatically weighted and compared to the needs of each patient in a very large group of patients.

The communication platform in combination with a “digital” house call can increase the effectiveness of the providers that make up a care team of doctors, nurses, pharmacists, counselors, clinical and administrative support staff, and the like. This Care Team can have a large number of patients for which they are responsible. In this sense, the technology system is less about single patients and more about increasing the capability of the Care Team to effectively manage a large number of patients.

Similar to a forest ranger in a forest, this is not so much about caring for a single tree, it is about caring for the entire forest. Individual information about each patient's condition is carefully gathered, automatically tagged, and stored in a manner that enables a deep understanding about that patient's specific needs. However, this process is in service of the Care Team's mission to provide primary care to ALL of their patients, and specifically focusing on those who may have immediate urgent needs that can be addressed by some member of the Care Team.

The communication platform is designed to manage a large cohort of patients including gathering patient-reported data about a health condition—those extending across long time periods, assessing the data to identify potential health issues and tagging each with various levels of urgency, identifying patients who have failed to respond to requests for information (no response alerts, identifying those cohort members where Care Team intervention is needed in the near term, providing relevant, summarized information to an appropriate team member to decide next action. Communicating to an in-need patient the actions they should immediately take, e.g., “call this phone #now”, providing summarized information that is key to Care Team member who will intervene with the patient, and the like. To accomplish these steps successfully requires a highly complex set of interlinked technology systems all aimed at achieving the goal stated above.

At the patient level, one purpose for gathering the data is from many patients is to compare it against similar patients and triage any situations that arise using other solutions triaged against similar data for many, many other patients with the same clinical condition. The patient data can also be used to inform the appropriate Care Team member about a patient's needs when an intervention is desired to address some problem that has been identified.

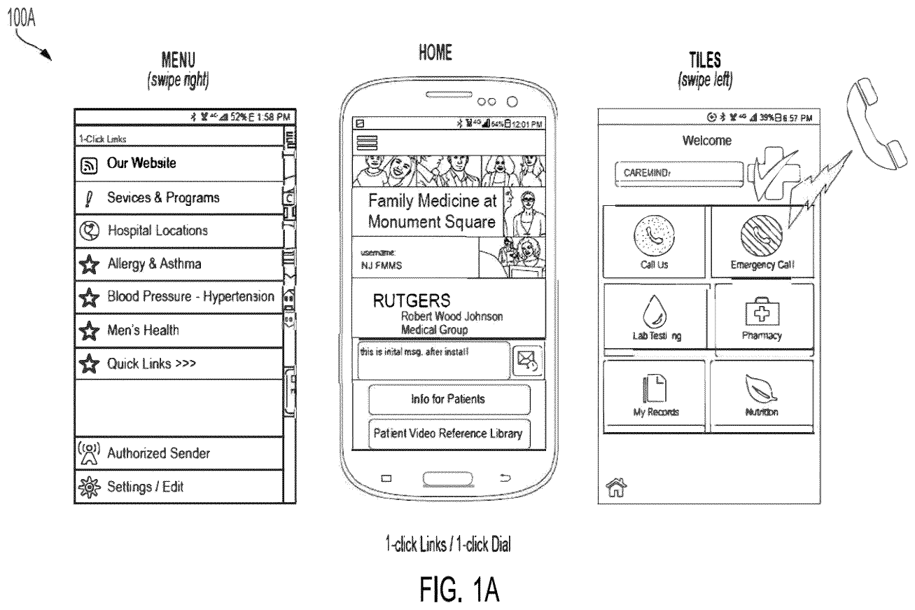

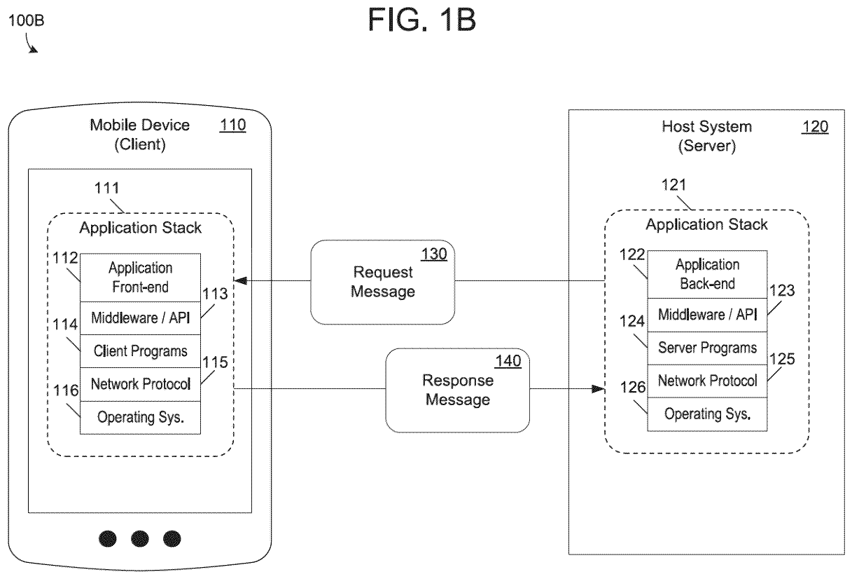

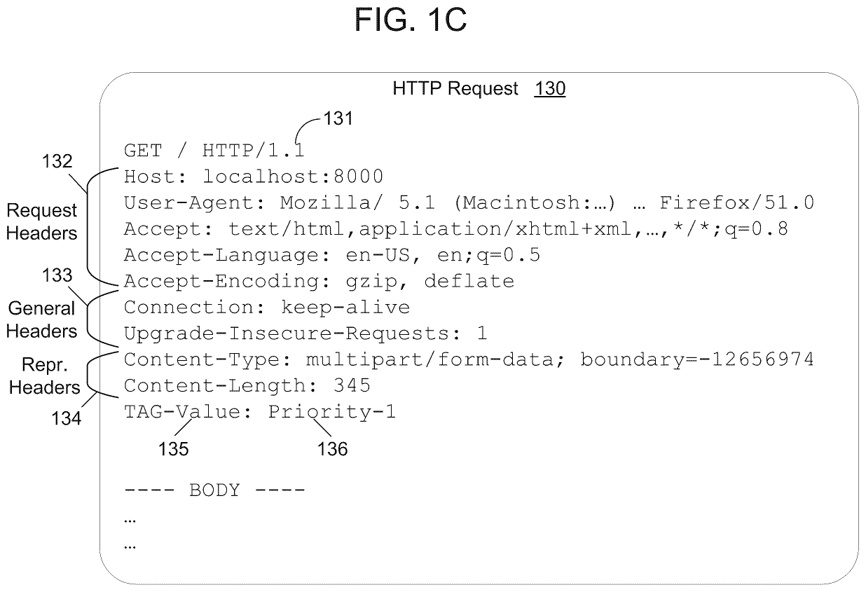

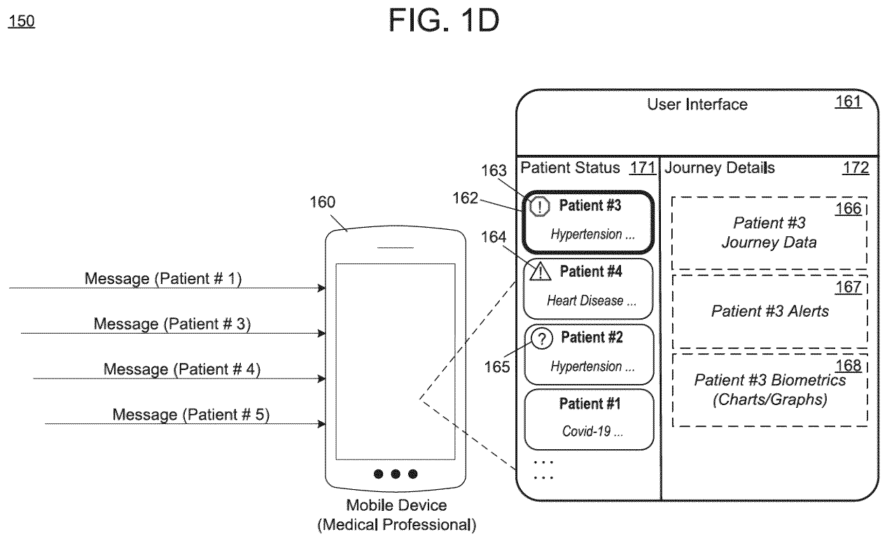

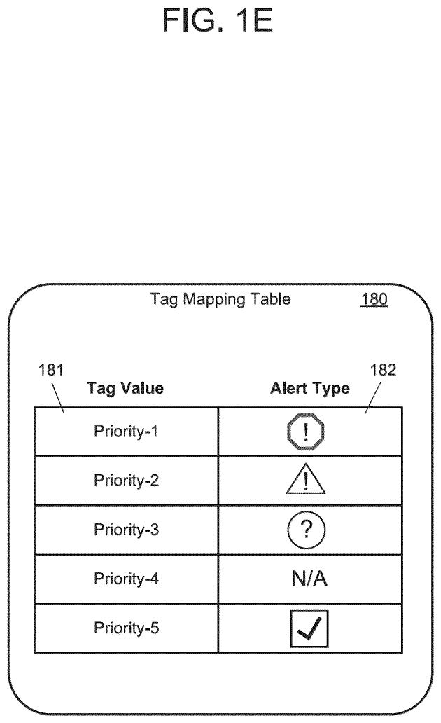

FIG. 1A illustrates an example of the integrated application platform 100 according to example embodiments. Referring to FIG. 1A, the application platform 100 includes a user interface that may be interacted with by a user based on touch commands such as swipe commands or other user interface interactions. In this example, a home user interface 102 is initially displayed in the middle of the page when the application is first launched on a mobile device of a user such as a patient being remotely monitored by the application. The user interface 102 may include details of the patient and the patient's journey, etc. If the user (e.g., the patient, etc.) were to swipe right on the home user interface 102, the application may open or otherwise navigate to a menu user interface 104 with links to additional pages and content of the application that can be accessed with a single click or other user interface actions. As another example, if the user were to swipe left on the home user interface 102, the application may open a tiles menu 106 with selectable tiles for accessing third-party resources such as emergency services, the application technical assistance contact, lab test results, medical records, pharmacy information, and the like.

FIG. 1B illustrates an example of communication process 100B between a front-end software stack 111 and a back-end software stack 121 of the software application according to example embodiments. Referring to FIG. 1B., the software application described herein may be a mobile application, a progressive web application, a browser-based web application, and/or the like, which includes a front-end or client-side and a back-end or server-side. In FIG. 1B, a host system 120 (e.g., host of the software application described herein, etc.) performs the role of the server. The host system 120 may include one or more of a could platform, a web server, a virtual machine, a database, a distributed network of computers, and the like. The host system 120 may register users/clients such as medical professionals and patients.

Meanwhile, the patients and the medical professionals may perform the role of the client-side and may access and install the front-end application stack 111 via a mobile device 110 such as a tablet, a smartphone, a laptop, a notebook, a medical machine, or the like. For example, a medical professional may use mobile device 110 to download and install the front-end application stack 111 of the application. The user may also use the front-end application stack 111, such as programs, user interfaces, processes, functions, etc. within an application front-end 112 to register with the host system 120 and setup one or more patients of the medical professional. As another example, a patient could use mobile device 110 to register with the host system 120 as a patient of one or more medical professionals that are also participation.

As noted in FIG. 1B, the front-end application stack 111 and the back-end application stack 121 include common components include middleware 113 and 123, respectively, network protocol configurations 115 and 125, respectively, and operating system configurations 116 and 126. Meanwhile, the front-end application stack 111 may include an application front-end 112 while the back-end application stack 121 may include an application back-end 122. The application back-end 122 may include server-side programs, functions, content, and the like, which are not shared with an application front-end 112. Likewise, the application front-end 112 may include other programs, functions, user interface, content, and the like, which are not included in the application back-end 122.

The middleware 113 and 123 is the software which connects the application front-end 112 and the application back-end 122. It enables connectivity between the client and the server and can enhance process management, user engagement, authentication, content management, and the like. The middleware 113/123 may also include one or more application programming interfaces (APIs) which allow the client-side or the front-end application 112 on the mobile device 110 to access (e.g., read, write, modify, create, delete, etc.) data stored by the host system 120 (or other third-parties), software functions, and other software and data resources of the back-end application 122 on the host system 120. In addition, the application-front end 112 may access client-specific programs and content 114 such as executable scripts, style sheets (e.g., CSS, etc.), and the like, when displaying user interfaces, populating messages, retrieving user preferences, and the like. Meanwhile, the application back-end may access server-specific programs and content 124 such as executable scripts, style sheets (e.g., CSS, etc.), and the like, which are held/contained by the server-side and not the client-side.

In the example of FIG. 1B, the host system 120 sends a request message 130 to the mobile device 110. In particular, the back-end application 122 sends the request message 130 to the front-end application 112, via network configurations and other information contained in the software stack 121. Likewise, the application front-end 112 may transmit a response message 140 to the back-end application 122 on the host system 120.

FIG. 1C illustrates an example of a Hypertext Transfer Protocol (HTTP) request message 130 that may be transmitted in FIG. 1C, however, embodiments are not limited thereto. It should also be appreciated that the messages may not be in HTTP form, but may be in another format. The messages may include instant messages that are transmitted in-app. As another example, the messages may also include SMS messages, emails, or other types of electronic messages.

Referring to FIG. 1C, the request message 130 includes a start line 131 describe the requests to be implemented including a type of command (e.g., POST, PUT, GET, etc.) and a URL/network address. For example, “GET” refers to data being fetched by the server while “POST” refers to data being pushed to the server. The request message 130 also includes optional headers such as request headers 132, general headers 133, representative headers 134, and the like.

According to various embodiments, the messages that are transmitted between the front-end and the back-end of the application described herein may include tag values (e.g., tag value 136 in tag field 135. The tag values may represent visual tags that are to be displayed on a user interface, such as a patient status screen. The tags may represent priority among the different patients such as priority based on urgency of the care that is needed. The host system may determine the urgency based on the response from a patient or lack of responses from the patient, and may generate an alert of some kind in response. The alert may be a visual alert that is to be displayed on a screen of a medical professional.

FIG. 1D illustrates an example of a process 150 of tagging patient status bubbles (e.g., bubble 162, etc.) with visual alerts (e.g., visual alert 163, etc.) according to example embodiments. Referring to FIG. 1D, the mobile device 160 may receive messages from the host system (not shown) with updates to patient status. In response, the application may generate a user interface 161, or update the user interfaced 161, with details from the received messages. In the example of FIG. 1D, the user interface 160 includes a patient status window 171 and a journey details window 172 within the user interface 161 which display additional details from the messages.

The patient status window 171 includes a plurality of message bubbles such as bubble 162 with status information of Patient #3. In this example, the sender of the messages (e.g., the host system 120 of the back-end software application 122 in FIG. 1B, etc.) may insert a respective alert tag into each message indicating a level of urgency of each respective patient. In response, the mobile device 160 (e.g., the front-end of the application 112 in FIG. 1B, etc.) may read the alert tag and generate a visual alert icon, graphic, or other visual element on the screen.

In FIG. 1D, the host system embeds a tag that identifies Patient #3 as having the most severe urgency level. In response, the mobile device may populate the bubble 162 of Patient #3 with the visual alert 163. The visual alert 163 may be embedded with the status bubble of Patient #3 thereby enabling the viewer to easily and quickly comprehend that Patient #3 needs attention first. In addition, the front-end of the application may arrange, order, re-arrange, etc., the ordering of the bubbles in the patient status window 171 based on urgency. For example, the application may move status bubbles of patients with the most severe level of urgency to the top, followed by patients with a less severe level of urgency, etc. Also, the application may populate the journey details window 172 with patient data of the currently selected patient within the patient status window 171. The patient data may include journey data 166, alert messages 167, biometrics 168 such as charts, graphs, readings, etc., and the like. In this example, the currently selected patient is Patient #3 because the user pressed/touched the message bubble 162 of Patient #3.

FIG. 1E illustrates an example of a tag-to-alert mapping table 180 according to example embodiments. Referring to FIG. 1E, the table 180 includes a plurality of tag values stored in a first column 181 that are paired with (i.e., mapped to) a plurality of alert types in a second column 182. The plurality of tag values may include a plurality of identifiers that can be embedded within tag fields of messages transmitted between the front-end and back-end of the application, and vice versa. Meanwhile, the alert types include visual alerts (e.g., icons, graphics, symbols, images, etc.) which should be displayed on the screen in response to receiving a message with a corresponding tag value. In some embodiments, the alert types may include attributes of the visual display such as CSS styling information, one or more scripts for executing and displaying the alert type and additional data, and the like.

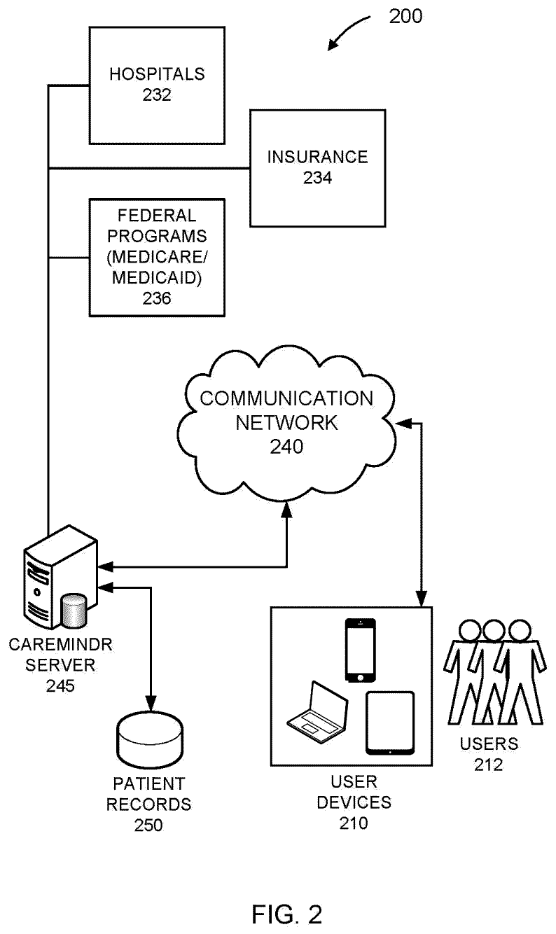

FIG. 2 illustrates a network configuration of the third-party participants of the integrated application according to example embodiments. Referring to FIG. 2, the network includes a central server 245 with patient records 250. The information needed to provide treatment plans and other integrated services may require access to hospital and other provider services 232, insurance company information 234, drug providers, federal program administrators 236, etc. The information may be incorporated into any treatment plan or other integrated service model accessed by a user device 210 operated by a user 212. The servers and third-party modules may operate on-site or in a cloud network managed by the providers.

Examples of treatment plans and other objectives may include a care management service for assessment of patient medical needs. The system and application may ensure timely receipt of all recommended treatment actions, drugs, third-party services and over a designated period. Also, referrals to other providers and additional services may provide emergency visits, discharge instructions, nursing facility operations, and home health care functions. In operation, the procedure may begin with the medical treatment provider creating a treatment plan or ‘journey’ for each patient. Each journey is generally for a single chronic condition or objective. One patient may have multiple journeys integrated into a single application. Also, the journeys may originate from various providers and service entities. The journey will provide the healthcare provider with biometric, objective and subjective data to enable evidence-based medical decisions. As an example, the biometric data may be glucometer data collected from a blue tooth enabled device and made available to the physician, objective data such as whether the patient visited an emergency room or hospital and subjective data such as how the patient is feeling.

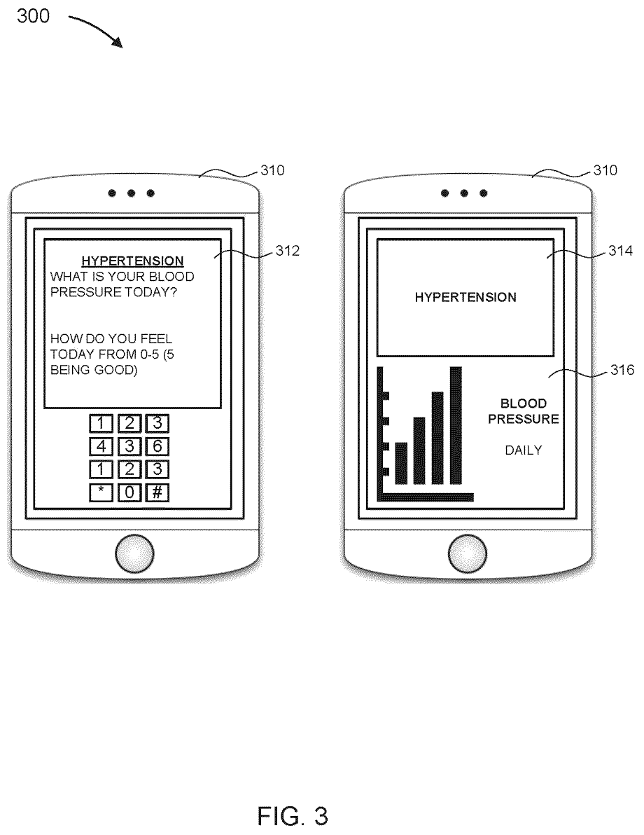

FIG. 3 illustrates a user smartphone interface of an example treatment plan according to example embodiments. Referring to FIG. 3, the journey for “hypertension” may have been created or modified by a patient doctor and may include an interface 300 with a smartphone device 310 and a screen option configuration providing questions 312, information about the treatment, reminders and other functions. The example in FIG. 3 provides for a set of questions 312 and a journey topic 314 along with a graph of blood pressure records 316 as measured over time from various interactions.

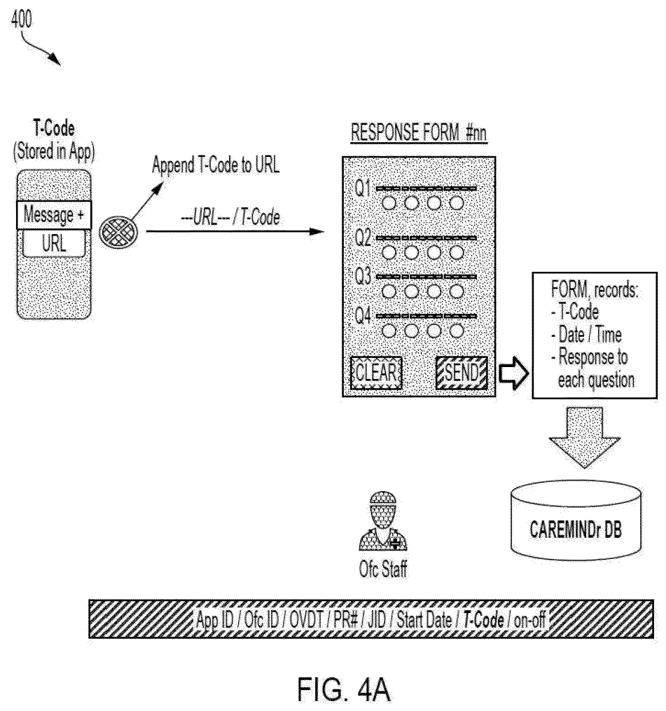

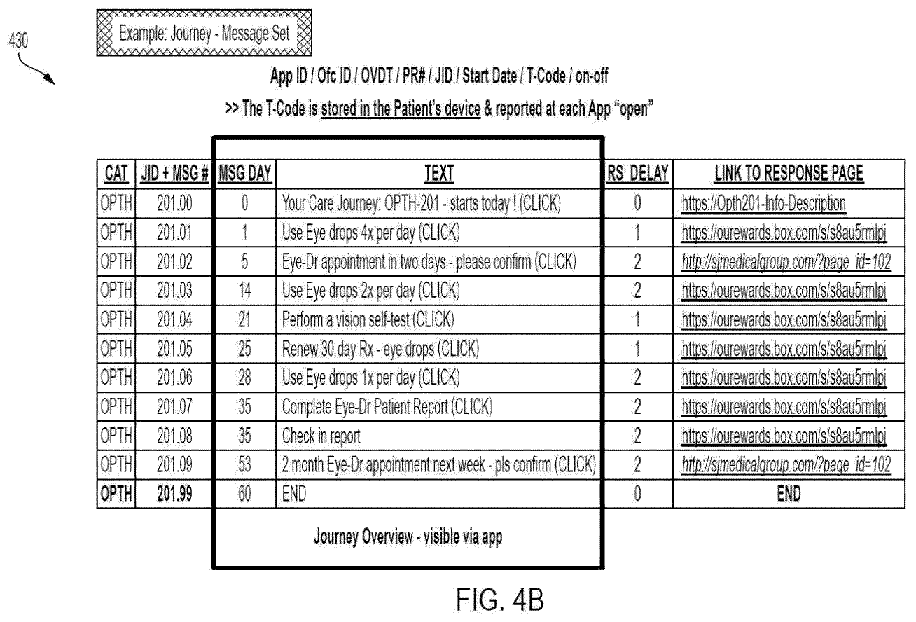

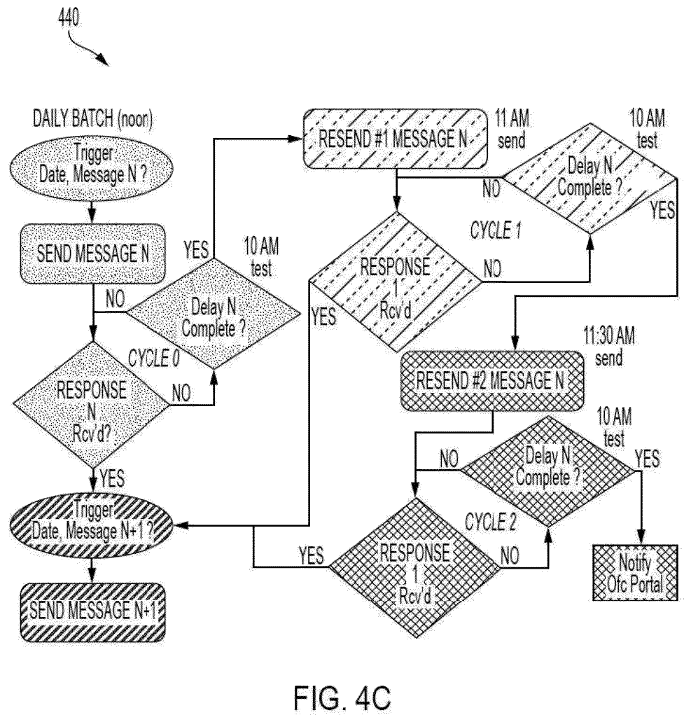

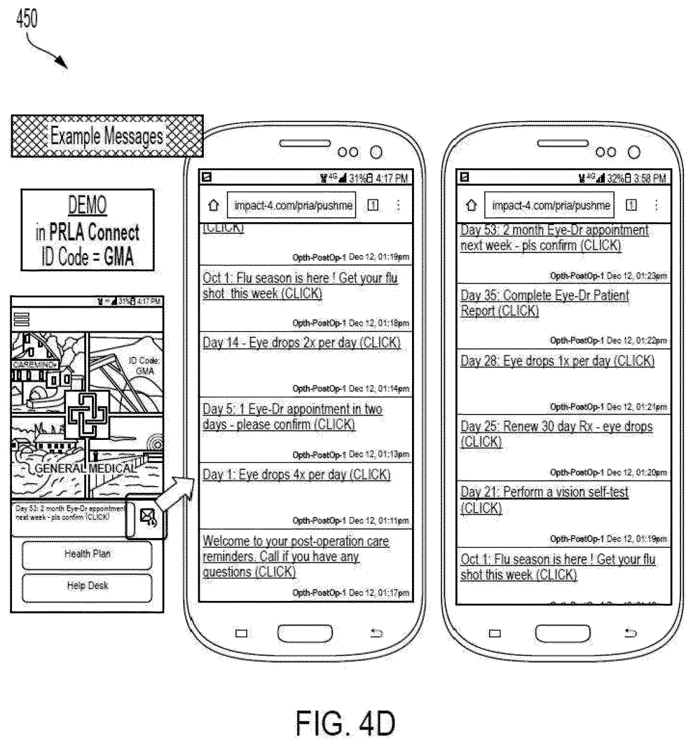

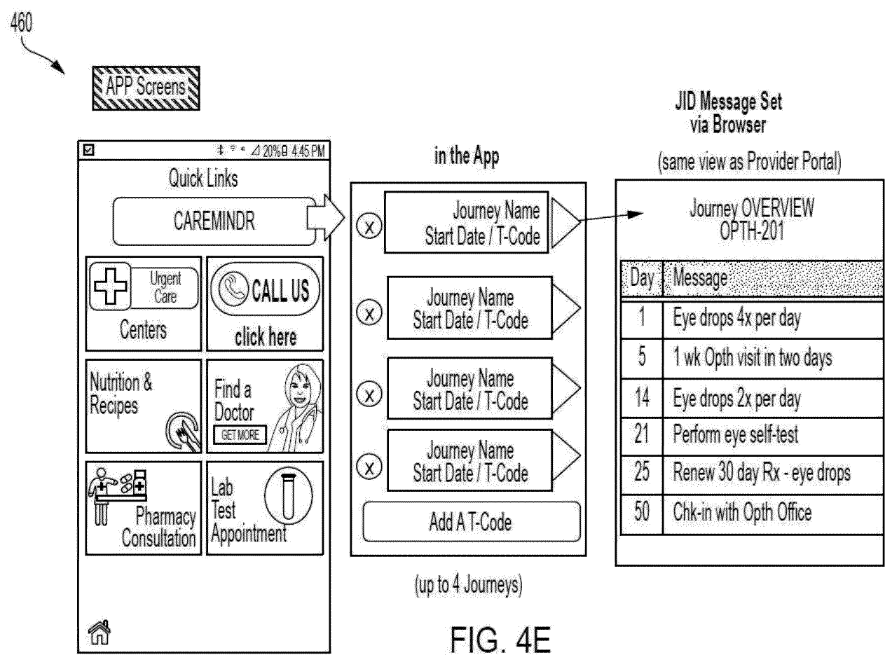

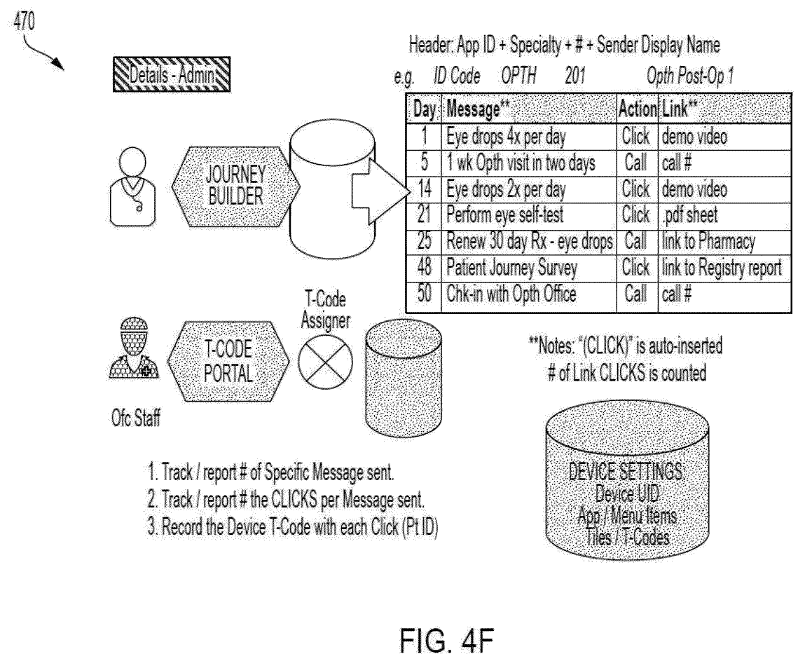

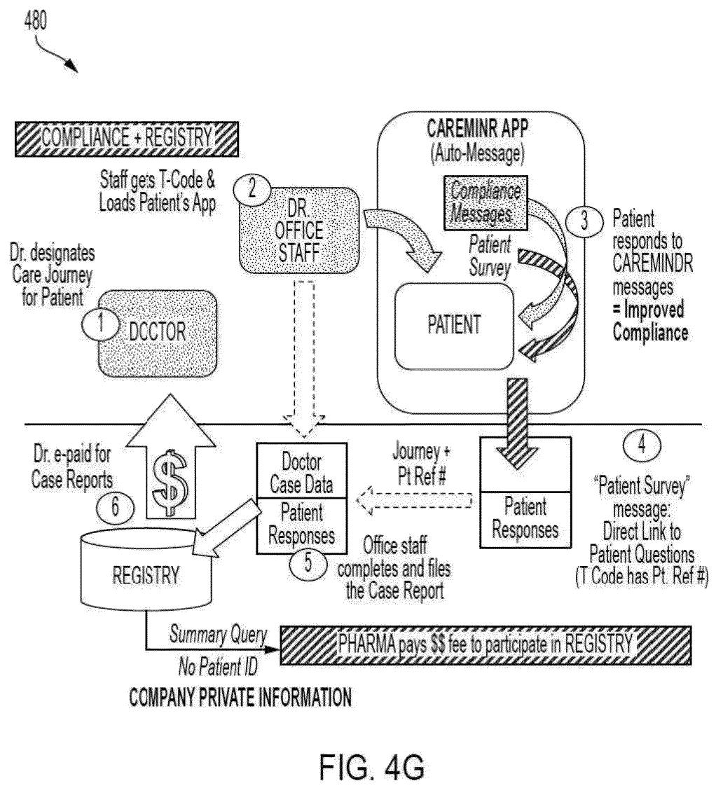

FIG. 4A illustrates an example setup configuration for a new course of treatment according to example embodiments. Referring to FIG. 4A, the illustration 400 includes the basic setup functions of linking a particular journey T-code (a unique code assigned by the system to that patient at the start of the specific journey) to the message and/or universal resource locator (URL) to link the application of the user to a customized template, such as a response form, questionnaire, etc. The unique T-code, date, time, response, and other records for each instance may be stored in a patient record managed by the application system database.

FIG. 4B illustrates an example database entry for the new course of treatment according to example embodiments. Referring to FIG. 4B, the example configuration 430 includes a database entry of messages which are organized by a category, in this case ophthalmology, and with a message content, including a link to a response page. The context and add-ons of a particular message may be customized based on a preferred layout or a default layout.

FIG. 4C illustrates a flow diagram 440 configuration for the new course of treatment according to example embodiments. Referring to FIG. 4C, the flow diagram includes a daily batch of messages which are setup to be delivered to one or more assigned patients. The process begins with a trigger to send a message, such as a matured date or time. The process then continues to deliver additional messages once confirmation of delivery is made. If the message is delayed or the response required is not received, the message may be resent as a late message requiring immediate attention. The process may continue to cycle to identify whether any messages are outstanding or have not been confirmed.

FIG. 4D illustrates an example list of messages for the ongoing course of treatment according to example embodiments. Referring to FIG. 4D, in this illustration 450, the various messages intended for a particular patient are illustrated by date. FIG. 4E illustrates an example setup configuration for various courses of treatment according to example embodiments. Referring to FIG. 4E, the configuration 460 includes a menu of options along with a set of potential journeys the user may be assigned to manage the ongoing health care treatment plans for that user. The overview of treatment options and dates are included for reference purposes.

FIG. 4F illustrates an example set of details of an ongoing course of treatment according to example embodiments. Referring to FIG. 4F, the details of the administrator are shown to include a journey builder function based on certain parameters, such as an identification code, specialty, a number and a sender name. The number of messages, responses and actions are recorded to demonstrate the user's interaction with the application and the specific treatment plan(s).

FIG. 4G illustrates an example network configuration of the various third parties involved in the application operation and compliance according to example embodiments. Referring to FIG. 4G, the large-scale network of communications among the integrated platform 480 demonstrates the process initiating with the doctor's office establishing a journey for the patient and assigning a T-code (unique code). The patient's responses are identified along with links and references to third party message links and other information sources.

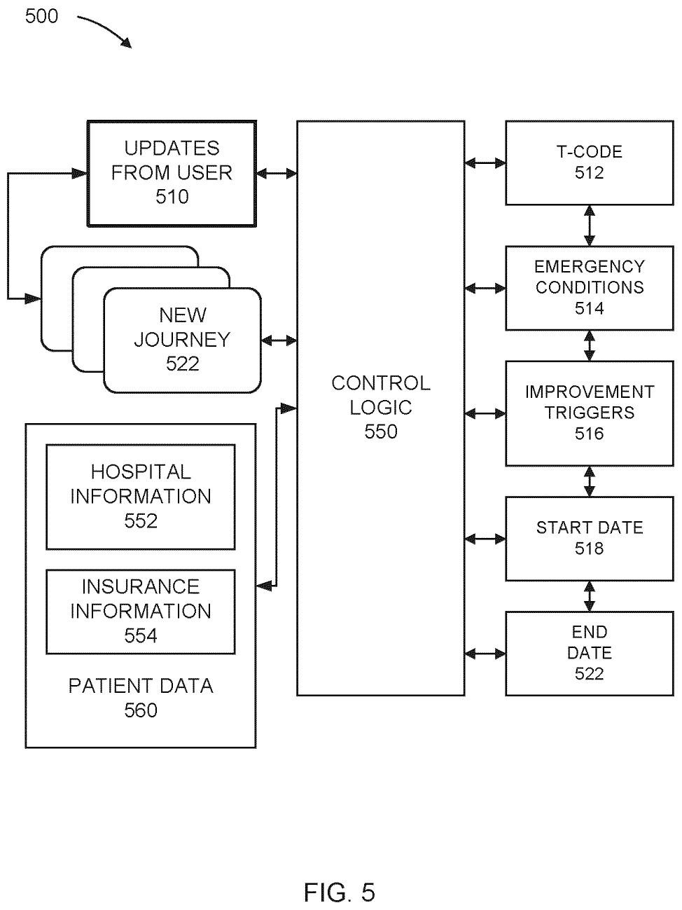

FIG. 5 illustrates a logic module configured to process the input and output parameters of the application according to example embodiments. Referring to FIG. 5, the control logic platform 500 includes a control logic unit 555, such as a processor or other processing entity that may receive updates from a user 510, new journey information 522 and/or patient data 560 including hospital 552, insurance 554, and other information. The logic may be configured to identify and link the unique T-code 512, emergency conditions 514, improvement triggers 516 for optimal changes to the treatment plan, along with dates 518 and new journey information 522 to perform the treatment plan.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments, a user device, such as a smartphone, cellular phone, tablet device, laptop or other computing device with a memory and processor, may communicate with another computing device and/or a server to provide an integrated communication platform.

Example embodiments provide a computer system programmed to use automated messaging from medical offices to specific patients. The application is not limited to medical procedures and functions and may be used with other configurations for various purposes and services benefitting the end user. Example embodiments include three main computer systems, which work together in an integrated manner including a management platform that controls set-up, functionality, activity reporting, and messaging credentials for the users. An administrative platform which the doctor and doctor's office can access via the internet, and a mobile application that a patient can download into a mobile computer device such as a smartphone or tablet. The management platform acts as the nexus of the system sending outgoing messages on behalf of the healthcare provider and forwarding patient responses to the healthcare provider's administrative platform. The medical office may have a specific identification that is stored within the management platform.

The integrated platform provides a way of checking-in with a patient at prescribed intervals during times between office visits and when undergoing certain treatment that the doctor is providing or overseeing for the patient. The patient dialog may gather relevant information about the status of the patient's conditions or recovery and can be modified or tailored to specifically meet the dialog requirements of the treating physician. Once initiated by the doctor's office, the application operates in an autonomous manner by delivering messages to the patient to prompt responses if needed. The application functions are monitored in the WatchTower to assure that the patient replies to the information requests from the doctor, otherwise a no-response alert is sent to the doctor's office. The interactions are recorded and time-stamped, providing an auditable record of the dialog, suitable for insurance billing purposes. The application can also support biometric information from devices that measure certain body functions, such as diabetes glucometers, or blood pressure cuffs, or any sensory readable health care metric. The application may also create a longitudinal record of information for the patient to illustrate week-to-week trends.

### Response Alert Tags

As has been stated earlier, this method and system is utilized when a patient visits a healthcare provider for an illness/condition which is diagnosed and treated. The treatment occurs over a period and is referred to as a journey. The system tracks a patient's progress along the journey for that illness or condition and solicits health information from the patient at clinically relevant intervals, across an extended time period to enable evidence-based medicine. The specific information sought, the intervals, and the time period duration apply to specific conditions or illnesses for which a specific patient is being treated.

This solicitation for patient information may take the form of queries sent to the patient for information when the responses to those queries are delivered to the patient's healthcare provider (e.g. physician). The patient's journey may have several waypoints occurring at the clinically relevant intervals. The responses to the queries at these waypoints are meant to determine a patient's progress and status and to present to the healthcare provider evidence upon which to conduct evidence-based medicine. The responses are collected by the Watchtower system and measured against historical norms for the patient and/or expected answers for many other similar patients on similar journeys.

In the event of an unexpected response to a query at that waypoint, the response is treated as notable. Notable events may be considered non-urgent or may be considered urgent and/or emergent. This divergence from the expected response outcome is graded for severity or urgency. If the severity or urgency of the response exceeds a predetermined threshold for that patient for that journey for that illness or condition at that waypoint, an urgent tag may be created and sent to the Care Team. The grading may be one of an immediate medical action advisory, a follow-up advisory, a medical history review advisory, and the like.

The information requested in the query is sent in a structured format to allow ease in answering and the response data is delivered to the Care Team in a structured data format to facilitate ease in analysis, trend detection and triage determination. As an example, the request may be sent in the form of an electronic communication via the application. Here, the host of the application may populate a user interface on a front-end of the application with a message, interactive buttons, menu items, options, tiles, links, selectable actions, and the like.

The response alert tag is a feature that “tags” certain responses provided by the patient as information that requires follow-up or special notice by the patient's healthcare provider. The tag may indicate a level of severity or urgency, thus alerting the provider to information that may need immediate medical action, additional follow-up with the patient or a specific review of the patient's medical history.

The tag may be communicated to the Care Team through multiple channels depending upon circumstance and urgency and in an immediate manner or in a weekly aggregated format depending in part upon urgency.

Workflow instructions may be electronically linked to a tag, so that the specific member of the Care Team that reviews the data will have guidance about the actions to be taken when a tag appears and any escalation of clinical review that might be appropriate.

Each patient for each illness or condition is interacted with by the system at intervals which are relevant to that illness or condition and the queries are sent to determine the patient's progress or status. The received response to the query is measured against an expected response, and anomalies or offsets are noted. If these response anomalies or offsets are larger than a predetermined amount, an urgent or severe issue may need to be addressed. Thus, the response is tagged as an urgent tagged response and may be sent utilizing a priority delivery schedule, a priority delivery indicia on the response and may be made to a priority delivery list determined by the healthcare provider. The response may be tagged as non-urgent if the determined urgency level does not meet the predetermined urgency threshold of the patient for the health-related issue.

The structured format allows an overlap of queries so that the patient is not answering multiple identical queries at any one point in time. Additionally, the structured format allows the data to be collected and logged in a structured format and assembled for future review both by the practitioner and the patient to determine trends.

In one example a method, includes requesting via a cloud-based system from a patient response to a query and receiving the response to the health-related query, determining an urgency level of the response based on the patient health-related issue and tagging the response as an urgent tagged response if the determined urgency level exceeds a predetermined urgency threshold of the patient for the health-related issue.

The method also includes providing the urgent tagged response to the Care Team, where the urgent tagged response may be sent utilizing a priority delivery schedule, a priority delivery indicia for the response and may be made to a priority delivery list.

The method may also include tagging the response as non-urgent if the determined urgency level does not meet the predetermined urgency threshold of the patient for the health-related issue.

If the determined urgency level of the response is such that it rises to the level of a medical emergency, then the primary care physician may be immediately notified as well as emergency services such as 911 and if deemed appropriate, dispatched to the location identified either by the patient or gathered from a location indicator in his mobile device. If the response is deemed critical, in situations where the primary physician is not immediately available, an emergency medical specialist may be placed in active direct communication with the patient. The system would make available to the first responder the query and response to provide context for the escalation.

The response may be graded as to the tagged urgency level of the response, where the grading is at least one of an immediate medical action advisory, a follow-up advisory and a medical history review advisory. A follow-on query may be sent based on the urgent tagged response to give the provider context to the urgent tagged response. As an example, if the patient responds that they have been to the emergency room (ER) that may trigger another set of queries about the ER visit to add context to the response. This second set of queries may determine whether the ER visit was related to conditions or illnesses related to the journey, or whether visit was for a condition unrelated to the journey, but still of interest to the healthcare provider.

In another example a cloud-based system links a mobile device and a healthcare provider server. The cloud-based system requests a response to a query from a patient pertaining to a health-related issue, receives the response to the query and determines an urgency level of the response based on the patient health-related issue. The system also tags the response as an urgent tagged response if the determined urgency level exceeds a predetermined urgency threshold of the patient for the health-related issue and provides the urgent tagged response to health provider.

The cloud-based system may receive via the mobile device a sensor signal provided by a medical device in response to the query. The medical device may be a blood pressure monitor, a glucometer, a pulse meter, a continuous positive airway pressure device, a heart monitor, an implanted medical device and the like.

The cloud-based system may receive via the mobile device an audio or text message indicating a medical distress condition in response to the query or may overhear the patient indicating a medical distress condition in conversations or texts in an unsolicited message.

The system may also interpret patient actions in regards to patient historical norms, such as, if the patient is overheard slurring his speech, he may be having a stroke, or if he is discussing that he has pressure in his chest or his left arm is numb, he may be having a heart attack. At this point the system may connect him directly to a medical specialist that is a member of the Care Team and take other appropriate action, such as determining his location and dispatching emergency services.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

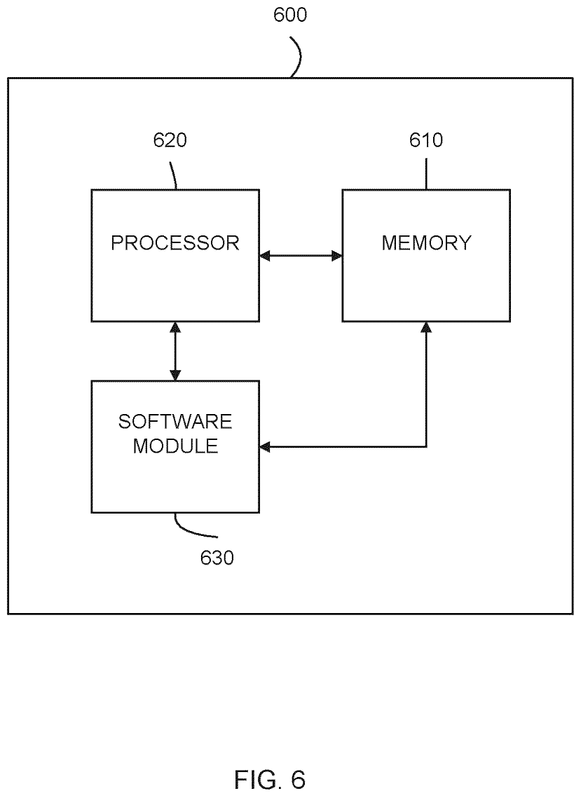

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example network element, which may represent any of the above-described network components of the other figures.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

According to various embodiments, the communication platform described herein may perform the function of a “watchtower” similar to a forest ranger watching the trees in the forest. In such a scenario, the forest ranger will look for only those specific trees that need help, and focus/divert resources to those specific trees. Similarly, in the present application, the communication platform can identify specific patients that are in more urgent need than others, and divert/route resources to the patients in more urgent need in an efficient manner that enables a small Care Team (such as a single health center) to remotely monitor thousands of patients, if not more.

The watchtower function may perform at least six functions including gathering intelligence, generating alerts, triaging the most urgent medical scenarios, daily messaging, connection to a database, and trend and reporting capabilities. For the more urgent medical scenarios, the communication platform can generate and send alerts to patients, medical personal, emergency services, and the like. The platform may also issue warnings, and suggested courses of action. The platform can “shoulder” the responsibility for a number of different tasks that would otherwise require a large group of humans. The communication platform can relieve the users from having to perform these tasks, and instead, rely on only a small response team of medical professionals who “watch” patients via the communication platform. The platform can monitor patient responses to daily/regular messages and identify the people that are in need. Then, the Care Team can focus response on the patients that need the most help.

The monitoring process is an iterative process. At periodic frequencies, for example, daily, weekly, monthly, etc. a patient receives a “digital house call” in the form of a questionnaire. The patient may receive a message from the host platform with a list of questions or other queries such as queries for vital readings, etc. The patient (or reading device) may submit answers/readings to the host platform. These responses are monitored. When a report comes in, sometimes there are flags. The system has looked at all answers, and has said this answer is a bad answer (several levels of degree). Some of the answers can be bad and a flag is going to be triggered. Flags are also around adherence to medication, sleep status, eating, etc. Some flags are low level. There are also more severe flags. Other flags include no-reply flags that are added when a user does not provide an answer back at an automated schedule.

For more severe alerts, the communication platform may transmit a notification/warning to the patient device and to the health center watching the patient. The message may include guidance such as suggestions on actions to take. The guidance can be personalized with a very specific message with a specific phone number and action to take for their specific condition. Waiting for the medical professionals to see the alert may be waiting too long. Therefore, a more severe alert/flag can be added to the message. This enables the communication platform to intervene with immediate medical assistance during an initial assessment of the patient, much earlier than before a doctor sees the patient. The platform can provide the patient with instructions of what to do right now.

By catching things early, the watchtower functionality can prevent subsequent problems down the road. The watchtower can make this process very efficient and also reduce health issues from lingering by taking immediate and early action (triage) to prevent a medical condition from worsening. Alerts can be based on “guardrails” (sensor boundaries) that can be set/reset at any time. For people that are starting way out of bounds, this can help them use different guardrails. AS they begin to improve, the guardrails can be modified to correspond to the patient's current status. This can prevent different false alarms from being raised.

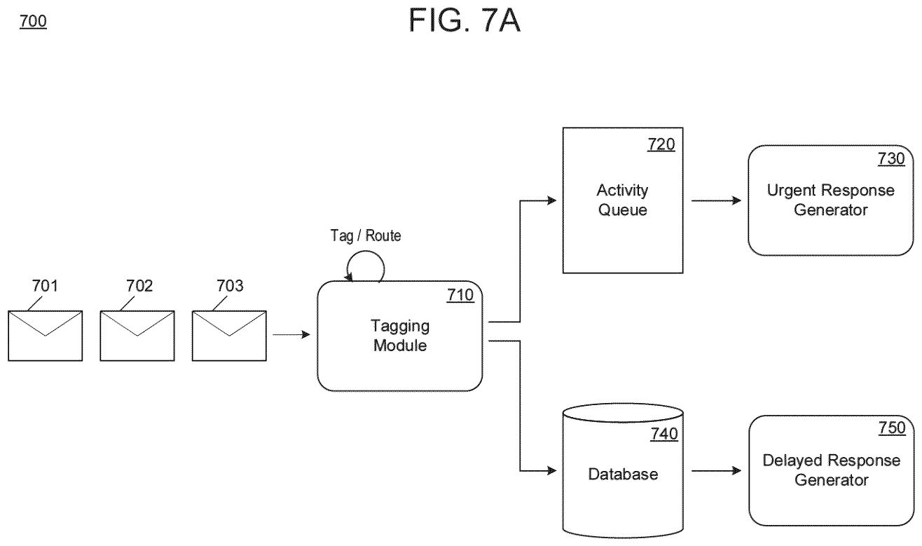

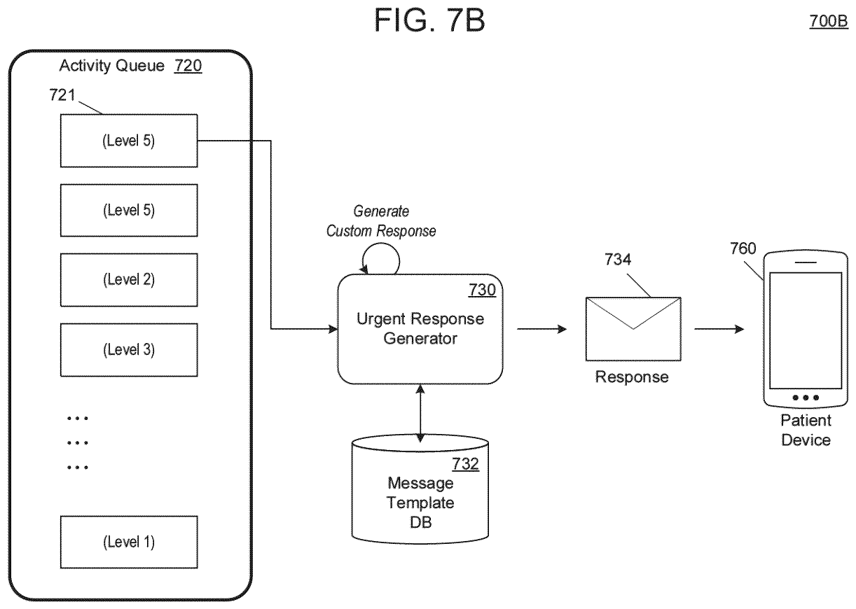

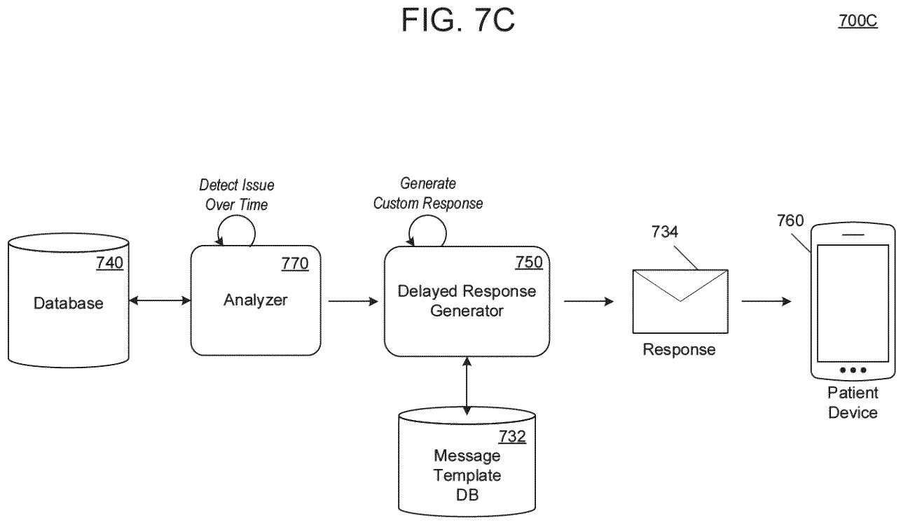

FIGS. 7A-7C illustrate a process of a watchtower communication platform according to example embodiments. For example, FIG. 7A illustrates a process 700 of tagging and routing patient response messages according to example embodiments. Referring to FIG. 7A, patients provide messages 701, 702, 703, etc. on a regular basis (e.g., daily, etc.) which are fed into a tagging module 710. The messages may include vital signs, sensor readings, answers to questions, etc. As the messages are received from patients (e.g., patient devices, blood pressure equipment, heart rate equipment, etc.), the messages are forward to a tagging module 710.

The tagging module 710 can analyze message content and identify a level of severity associated with the message. As an example, the level of severity may the same as or similar to the levels shown in FIG. 1E. The different severity levels/types may include very severe, severe, somewhat severe, urgent, normal, etc. The tags may be embedded within message headers, such as HTTP headers of the messages. The tags can be read and used by messaging module(s) that review the tagged messages from the patients and generate response messages.

For example, after the tagging module 710 has tagged a message, the tagging module 710 may determine whether to route the message to an activity queue 720 for more urgent processing, or to a database 740 where it is aggregated with previous received data from the patient. For tagged messages that are routed to the activity queue 720, an urgent response generator 730 may analyze the tags on each message, and determine a priority among the corresponding response messages to be sent to the patients. More urgent/severe patient conditions can be moved up in the activity queue 720 as shown in FIG. 7B.

Referring to FIG. 7B, a process 700B of retrieve a most urgent message 721 from the activity queue 720 and generating and sending a corresponding response message is shown. Here, the urgent response generator 730 may analyze the tags on the messages that are stored in the activity queue 720 and identify a most urgent/next message to be submitted based on the tags. A more severe tag can be given priority over less severe tags, even when the message with the less severe tag is received prior to the message with the more severe tag.

The urgent response generator 730 may store a list of message templates in a database 732. The message templates may be paired with severity types. For example, a most severe type may have a predefined message format while a less sever type may have a different predefined message format. Each message template may have blanks that can be filled in the urgent response generator 730 (or the delayed response generator 750).

In the example of FIG. 7B, the urgent response generator 730 generates a response message 734 in response to the most urgent tagged message 721, and sends the response message 734 to a user device 760 of the patient. As another example, the urgent response generator 730 may deliver the response to other parties in addition to or instead of the patient. In some cases, the urgent response generator 730 may simultaneously output messages to different systems based on the same urgent tagged message. For example, the platform may issue an urgent response message to a device of the patient and also an urgent response message to a device of the medical team in charge of the patient.

Referring again to FIG. 7A, for messages that are tagged as normal, wait-and-see, etc., the messages may be stored within a database 740 with other messages. The content of these messages may be analyzed via an analyzer 770 as shown in FIG. 7C. In particular, FIG. 7C illustrates a process 700C of detecting a severe issue from messages that have been tagged as normal or not as severe. Here, the analyzer 770 may aggregate data of a patient over time and analyze it using one or more expert models, machine learning models, artificial intelligence models, or the like. The models may detect patterns within the aggregated data which may not look like a severe issue at first, but when aggregated, the severity becomes more clear.

For example, a patient with a blood pressure reading that is just a little above normal may not trigger a severe tag. However, 10 days in a row of such a reading may be detected by the analyzer 770 as being a more severe issue, possibly. In this case, the analyzer 770 can trigger an urgent notification via a delayed response generator 750 which can use message templates from the database 732 and fill them in and send them to the patient device 760. Here, the delayed response generator 750 may perform the same functions as the urgent response generator 730. In some cases, the delayed response generator 750 and the urgent response generator 730 may be the same module but are shown separately for convenience of explanation.

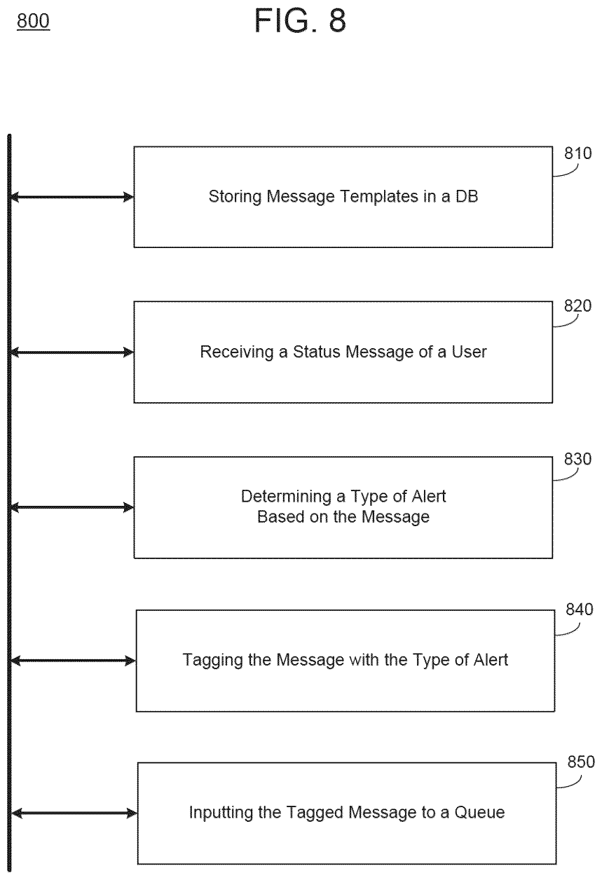

FIG. 8 illustrates a method of tagging and routing messages through a watchtower platform according to example embodiments. For example, the method 800 may be performed by a host platform such as a web server, a cloud platform, a database, an on-premises server, and the like. Referring to FIG. 8, in 810, the method may include storing a plurality of message templates corresponding to a plurality of tags. In 820, the method may include receiving, from a user device, a message with status information about a user of the user device. In 830, the method may include determining that the message comprises a type of alert from among a plurality of types of alerts. In 840, the method may include tagging the message with the type of alert. In 850, the method may include storing the tagged message within a queue.

In some embodiments, the method may further include identifying a most urgent tagged message within the queue, generating a response message to the urgent tagged message, and sending the response message to a corresponding user device associated with the most urgent tagged message. In some embodiments, the method may further include retrieving a message template from a database based on the type of alert, and filling in the message template with response content based on the most urgent tagged message to generate the response message. In some embodiments, the method may further include storing a mapping table that comprises a plurality of different alert tags corresponding to a plurality of levels of urgency, respectively, and each level of urgency is mapped to a different visual alert in the mapping table.

In some embodiments, the identifying may include comparing parameters extracted from the message to different parameter requirements for the plurality of different alert tags to determine the type of alert. In some embodiments, the method may further include simultaneously outputting a response message to a user device and a health center device based on the type of alert. In some embodiments, the message may include a hypertext transfer protocol (HTTP) message, and the tagging may include embedding an identifier of the type of alert within a header of the HTTP message.

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A computing system comprising:
a memory configured to store a plurality of message templates corresponding to a plurality of tags;
a queue; and
a processor configured to
receive, from a user device, a message with status information about a user of the user device,
determine that the message comprises a type of alert from among a plurality of types of alerts,
tag the message with the type of alert, and
input the tagged message to a queue.

2. The computing system of claim 1, wherein the processor is further configured to identify a most urgent tagged message within the queue, generate a response message to the urgent tagged message, and send the response message to a corresponding user device associated with the most urgent tagged message.

3. The computing system of claim 2, wherein the processor is configured to retrieve a message template from a database based on the type of alert, and fill in the message template with response content based on the most urgent tagged message to generate the response message.

4. The computing system of claim 1, wherein the memory is further configured to store a mapping table that comprises a plurality of different alert tags corresponding to a plurality of levels of urgency, respectively, and each level of urgency is mapped to a different visual alert in the mapping table.

5. The computing system of claim 4, wherein the processor is configured to compare parameters within the message to different parameter requirements for the plurality of different alert tags to determine the type of alert.

6. The computing system of claim 1, wherein the processor is configured to simultaneously output a response message to a user device and a health center device based on the type of alert.

7. The computing system of claim 1, wherein the message comprises a hypertext transfer protocol (HTTP) message, and the processor is configured to embed an identifier of the type of alert within a header of the HTTP message.

8. A method comprising:
storing a plurality of message templates corresponding to a plurality of tags;
receiving, from a user device, a message with status information about a user of the user device;
determining that the message comprises a type of alert from among a plurality of types of alerts;
tagging the message with the type of alert; and
input the tagged message to a queue.

9. The method of claim 8, wherein the method further comprises identifying a most urgent tagged message within the queue, generating a response message to the urgent tagged message, and sending the response message to a corresponding user device associated with the most urgent tagged message.

10. The method of claim 9, wherein the method further comprises retrieving a message template from a database based on the type of alert, and filling in the message template with response content based on the most urgent tagged message to generate the response message.

11. The method of claim 8, wherein the method further comprises storing a mapping table that comprises a plurality of different alert tags corresponding to a plurality of levels of urgency, respectively, and each level of urgency is mapped to a different visual alert in the mapping table.

12. The method of claim 11, wherein the identifying comprises comparing parameters extracted from the message to different parameter requirements for the plurality of different alert tags to determine the type of alert.

13. The method of claim 8, wherein the method further comprises simultaneously outputting a response message to a user device and a health center device based on the type of alert.

14. The method of claim 8, wherein the message comprises a hypertext transfer protocol (HTTP) message, and the tagging comprises embedding an identifier of the type of alert within a header of the HTTP message.

15. A computer-readable medium comprising instructions which when executed by a processor cause a computer to perform a method comprising:
storing a plurality of message templates corresponding to a plurality of tags;
receiving, from a user device, a message with status information about a user of the user device;
determining that the message comprises a type of alert from among a plurality of types of alerts;
tagging the message with the type of alert; and
inputting the tagged message to a queue.

16. The computer-readable medium of claim 15, wherein the method further comprises identifying a most urgent tagged message within the queue, generating a response message to the urgent tagged message, and sending the response message to a corresponding user device associated with the most urgent tagged message.

17. The computer-readable medium of claim 16, wherein the method further comprises retrieving a message template from a database based on the type of alert, and filling in the message template with response content based on the most urgent tagged message to generate the response message.

18. The computer-readable medium of claim 15, wherein the method further comprises storing a mapping table that comprises a plurality of different alert tags corresponding to a plurality of levels of urgency, respectively, and each level of urgency is mapped to a different visual alert in the mapping table.

19. The computer-readable medium of claim 18, wherein the identifying comprises comparing parameters extracted from the message to different parameter requirements for the plurality of different alert tags to determine the type of alert.

20. The computer-readable medium of claim 15, wherein the method further comprises simultaneously outputting a response message to a user device and a health center device based on the type of alert.
